(19) United States
(12) Patent Application Publication
(10) Pub. No.: US 2019/0204599 A1
(43) Pub. Date: Jul. 4, 2019

(54) HEAD-MOUNTED DISPLAY DEVICE WITH ELECTROMAGNETIC SENSOR

(71) Applicant: MICROSOFT TECHNOLOGY LICENSING, LLC, Redmond, WA (US)

(72) Inventor: Eric Charles ABBOTT, Fall City, WA (US)

(21) Appl. No.: 15/857,419

(22) Filed: Dec. 28, 2017

(51) Int. Cl. G02B 27/01; G06F 3/01; G02B 27/00; G06T 19/00; G06K 9/00

(52) U.S. Cl. CPC G02B 27/017; G06F 3/012; G06K 9/00671; G06T 19/006; G02B 27/0093

(57) ABSTRACT

In a head-mounted display device, one or more electromagnetic sensors are provided to improve both head tracking and surface mapping. For head tracking, velocity data provided by the electromagnetic sensors is used to replace the error-prone acceleration data provided by inertial measurement units and to reduce the reliance on tracking cameras. Such replacement results in more accurate and less computationally expensive orientation and position calculations. For surface mapping, distance data provided by the electromagnetic sensors is used to replace less accurate distance data provided by depth cameras, which results in more accurate three-dimensional meshes. Other advantages of electromagnetic sensors include object detection and/or hazard detection, which may improve the safety of head-mounted display devices.

### BACKGROUND

Head-mounted display (“HMD”) devices are currently used to provide virtual reality (“VR”) applications, augmented reality (“AR”) applications, and mixed reality (“MR”) applications. For VR applications, the HMD device obscures the wearer's vision of the real world, and a virtual world is rendered and displayed to the wearer. When the wearer moves their head (or body), the rendering of the virtual world is also changed to give the user the impression that they are in the virtual world. The process of determining the position and orientation of the HMD device as the user moves is known as head tracking. If the means for tracking the HMD device 100 is entirely contained within the HMD device, this is referred to as inside-out head tracking.

For AR and MR applications, the HMD device allows the wearer to see the real world, but the HMD device projects virtual objects into the wearer's field of view such that the virtual objects appear to exist in the real world. An example of an AR application is a map application that projects directions (e.g., turn left or turn right) onto the street in the wearer's field of view as the wearer travels a route.

MR applications are similar to AR applications in that they also project virtual objects into the wearer's field of view, but in MR applications, the virtual objects may appear to be more integrated into the real world. For example, a block building MR application may make virtual blocks appear to be sitting on a real world coffee table. The wearer may then interact with the virtual blocks using their hands, and the virtual blocks may respond as if they exist in the real world.

The HMD device may similarly determine the position and orientation of the HMD device using head tracking for both AR and MR applications. In addition, for MR applications, and to a lesser extent AR applications, the HMD device may also generate a three-dimensional model of the real world to allow for the realistic placement and interaction of the virtual objects with the real world. The process of creating and building this three-dimensional model is known as surface mapping.

Currently, there are drawbacks associated with how HMD devices perform both head tracking and surface mapping. For head tracking, current HMD devices rely on one or both of inertial sensors and tracking cameras. Inertial sensors are sensors such as gyroscopes, magnetometers, and accelerometers that measure the orientation and acceleration of the HMD device. Tracking cameras are cameras that determine the position or orientation of the HMD device by comparing successive images taken by the cameras to detect changes in position and orientation.

Because HMD devices are very cost sensitive, low cost inertial sensors are often used. Because of this, the inertial sensors are of low quality, which means that errors generated by the sensors are large and/or unstable with time. To compensate for these low quality inertial sensors, current systems compensate by increasing the framerate of the tracking cameras. However, such increased framerate may result in increased power consumption and processing resources of the HMD device, which may result in a poor experience for the wearer of the HMD device.

For surface mapping, current HMD devices rely on one or more depth cameras to map the surfaces surrounding each HMD device. The depth camera uses a laser (or other light source) to measure the distance between the HMD device and various objects in the wearer's field of view. As the wearer moves their head, the measurements from the depth camera are combined to create a three-dimensional model of the environment of the wearer. Depth cameras suffer from decreased accuracy with distance, and use a significant amount of power, both of which may result in a poor experience for the wearer of the HMD device.

### SUMMARY

In a head-mounted display device, one or more electromagnetic sensors are provided to improve both head tracking and surface mapping. Example electromagnetic sensors include radar sensors. For head tracking, velocity data provided by the electromagnetic sensors is used to replace the error-prone acceleration data provided by inertial measurement units and to reduce the reliance on tracking cameras. Such replacement of acceleration data with velocity data results in more accurate and less computationally expensive orientation and position calculations. For surface mapping, distance data provided by the electromagnetic sensors is used to replace less accurate distance data provided by depth cameras, which results in more accurate three-dimensional meshes. Other advantages of electromagnetic sensors include object or hazard detection, which may improve the safety of head-mounted display devices.

In an implementation, a system for providing augmented reality, mixed reality, and virtual reality applications using at least one electromagnetic sensor is provided. The system includes: at least one computing device; a controller; and an electromagnetic sensor. The electromagnetic sensor: transmits a first electromagnetic wave; receives a second electromagnetic wave; and based on the first electromagnetic wave and the second electromagnetic wave, generates velocity data. The controller: receives the generated velocity data; based on the velocity data, determines a position of the at least one computing device; and provides the determined position to one or more of a mixed reality, augmented reality, or a virtual reality application executed by the at least one computing device.

In an implementation, a system for providing augmented reality and mixed reality applications using at least one electromagnetic sensor is provided. The system includes: at least one computing device; a controller; and an electromagnetic sensor. The electromagnetic sensor: transmits a first electromagnetic wave; receives a second electromagnetic wave; and based on the first electromagnetic wave and the second electromagnetic wave, generates distance data. The controller: receives the generated distance data; based on the distance data, generates a three-dimensional mesh; and provides the generated three-dimensional mesh to a mixed reality application or an augmented reality application executing on the at least one computing device.

In an implementation, a method for providing augmented reality applications, mixed reality applications, and virtual reality applications using at least one electromagnetic sensor is provided. The method includes: transmitting a first electromagnetic wave by an electromagnetic sensor of a computing device; receiving a second electromagnetic wave by the electromagnetic sensor of the computing device; based on the first electromagnetic wave and the second electromagnetic wave, generating velocity data by the computing device; receiving inertial data from an inertial measurement unit of the computing device; based on the received inertial data and the generated velocity data, determining an orientation and a position of the computing device by the computing device; and providing the determined orientation and position to one of an augmented reality application, a mixed reality application, or a virtual reality application executing on the computing device by the computing device.

This summary is provided to introduce a selection of concepts in a simplified form that are further described below in the detailed description. This summary is not intended to identify key features or essential features of the claimed subject matter, nor is it intended to be used to limit the scope of the claimed subject matter.

### BRIEF DESCRIPTION OF THE DRAWINGS

The foregoing summary, as well as the following detailed description of illustrative embodiments, is better understood when read in conjunction with the appended drawings. For the purpose of illustrating the embodiments, example constructions of the embodiments are shown in the drawings; however, the embodiments are not limited to the specific methods and instrumentalities disclosed. In the drawings:

FIG. 1 is an illustration of an exemplary HMD device;

FIG. 2 is an illustration of an example environment that includes an HMD device performing head tracking using data provided by an inertial measurement unit (“IMU”) and tracking cameras;

FIG. 3 is an illustration of an example environment that includes an HMD device performing surface mapping using data provided by a depth camera;

FIG. 4 is an illustration of an example electromagnetic sensor that measures distance and velocity for the HMD device;

FIG. 5 is an illustration of an example controller that may be incorporated into an HMD device;

FIGS. 6 and 7 are illustrations of an example environment that includes an HMD device performing object detection;

FIG. 8 is an operational flow of an implementation of a method for determining an orientation and/or a position of an HMD device;

FIG. 9 is an operational flow of an implementation of a method for determining a three-dimensional mesh using an electromagnetic sensor of an HMD device;

FIG. 10 is an operational flow of an implementation of a method for detecting objects using an electromagnetic sensor of an HMD device; and

FIG. 11 shows an exemplary computing environment in which example embodiments and aspects may be implemented.

### DETAILED DESCRIPTION

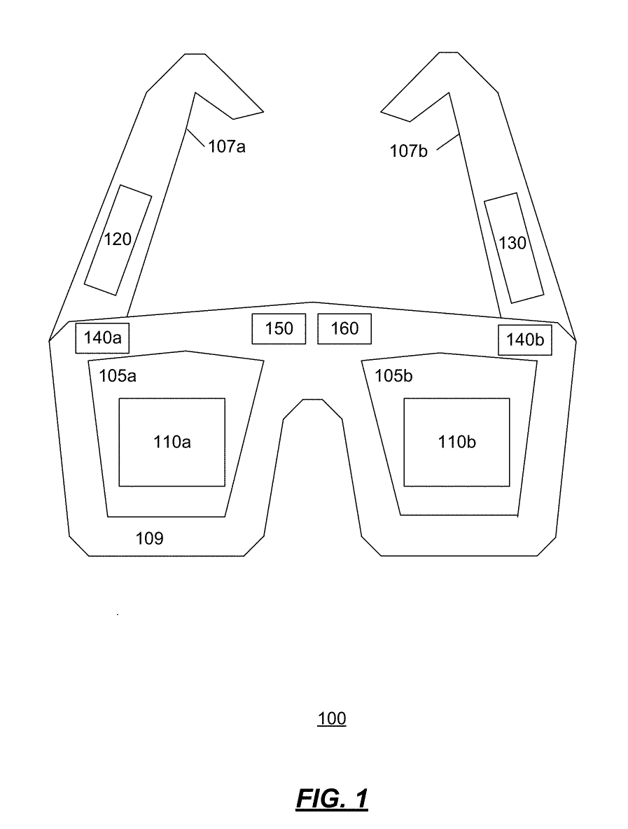

FIG. 1 is an illustration of an example head-mounted display (“HMD”) device 100, In an implementation, the HMD device 100 is comprised as or within a pair of glasses; however, other shapes and form factors may be supported. The HMD device 100 includes lenses 105a and 105b arranged within a frame 109. The frame 109 is connected to a pair of temples 107a and 107b. Arranged between each of the lenses 105a and 105b and a wearer's eyes is a near-eye display system 110a and 110b, respectively. The system 110a is arranged in front of a right eye and behind the lens 105a. The system 110b is arranged in front of a left eye and behind the lens 105b.

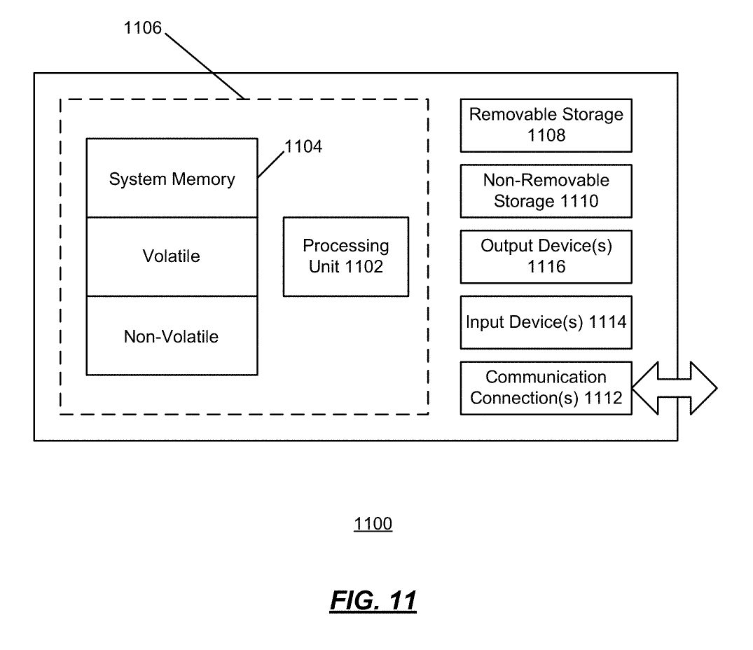

The HMD device 100 also includes a controller 120 and one or more inertial measurement units (“IMU”) 130. The controller 120 may be a computing device operatively coupled to both near-eye display systems 110a, 110b and to the IMU 130. A suitable computing device is the computing device 1100 described with respect to FIG. 11.

The IMU 130 may be arranged in any suitable location on the HMD device 100. The IMU 130 may provide inertial data that may be used by the controller 120 to perform what is known as head tracking where the position and orientation of the HMD device 100 is determined. In some implementations, the IMU 130 may include multiple sensors such as gyroscopes, accelerometers, and magnetometers. The sensors of the IMU 130 may provide inertial data such as angular rate data, acceleration data, and orientation data, that may be used by the controller 120 to calculate the position and orientation of the HMD device 100 with respect to a wearer's environment.

The HMD device 100 may further include one or more tracking cameras 140a, 140b that may be used by the controller 120 to perform head tracking. Depending on the implementation, each tracking camera 140a, 140b may continuously take images of the wearer's environment, and may provide the images to the controller 120. The controller 120 may compare the locations of common visual features or stationary points (i.e., walls, floors, or furniture) in subsequent images to estimate how the orientation and position of the HMD device 100 has changed between the subsequent images. The number of images that are captured by each tracking camera 140a, 140b per second is known as the framerate. The images produced by the tracking cameras 140a,140b may be combined with the inertial data provided by the IMU 130 by the controller 120 when performing head tracking.

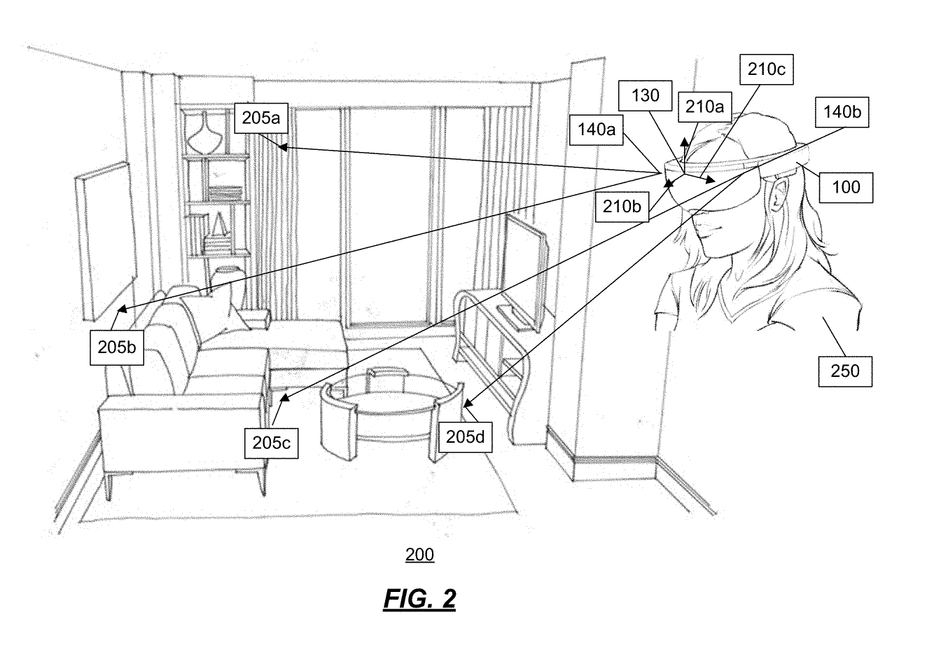

FIG. 2 is an illustration of an example environment 200 that includes an HMD device 100 performing head tracking using data provided by an IMU 130 and tracking cameras 140a, 140b. The IMU 130 may continuously generate inertial data such as acceleration data, angular rate data, and orientation data, which are illustrated in FIG. 2 as the vectors 210 (i.e., the vectors 210a, 210b, and 210c). Similarly, the tracking cameras 140a, 140b capture image data that includes various points within the environment 200. In the example shown, the tracking camera 140a captures the point 205a and the point 205b, and the tracking camera 140a captures the point 205c and the point 205d.

As a wearer 250 of the HMD device 100 moves their head and the HMD device 100, the changes in the inertial data represented by the vectors 210a, 210b, and 210c, are provided by the IMU 130 to the controller 120. At approximately the same time, the controller 120 may receive image data from the tracking cameras 140a and 140b and may compare the image data with previously received image data to determine changes in the locations of the points 205a, 205b, 205c, 205d that may indicate changes in the position and orientation of the HMD device 100. For example, a leftward rotation of the HMD device 100 may be indicated by the point 205d no longer being visible in image data received from the tracking camera 140b and the point 205b suddenly being visible in the image data received from the tracking camera 140b. Any method or technique for determining position and orientation based on changes to image data may be used.

Returning to FIG. 1, the HMD device 100 may include a depth camera 150. The depth camera 150 may be used by the controller 120 to perform what is known as surface mapping. Surface mapping is the process of detecting and reconstructing a model or three-dimensional mesh that represents the wearer's environment. The depth camera 150 may use a laser, or other technology, to make depth measurements between the depth camera 150 and every reflective surface within the field of view of the depth camera 150. The depth measurements collected fora given position and orientation of the depth camera 150 is referred to as a depth map.

As the wearer moves their head (and the HMD device 100), the depth camera 150 may capture depth maps at different positions and orientations. The controller 120 may receive these depth maps, and may “stitch” the maps together to create a three-dimensional mesh that represents the environment of the wearer of the HMD device 100. The controller 120 may continue to update the three-dimensional mesh as additional depth maps are received from the depth camera 150.

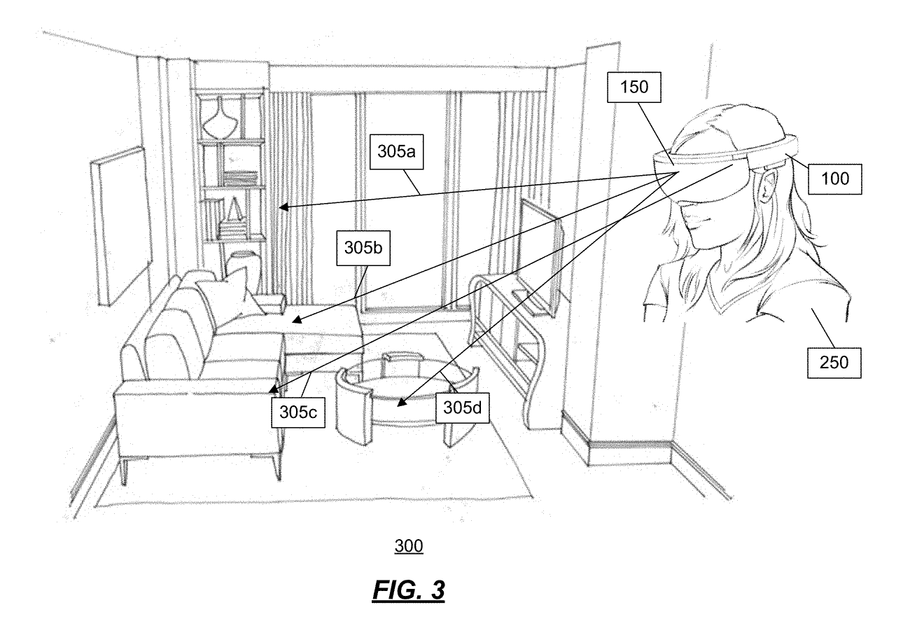

FIG. 3 is an illustration of an example environment 300 that includes an HMD device 100 performing surface mapping using data provided by a depth camera 150. As the wearer 250 of the HMD device 100 moves their head and the HMD device 100 within the environment 300, the depth camera 150 uses a laser to generate and emit a plurality of pulses of light 305 (i.e., the pulses 305a, 305b, 305c, and 305d) that each have a known frequency and phase in the field of view of the depth camera 150. Each of the emitted pulses 305 are reflected off a particular point of the environment 300 and received by the depth camera 150. The time each pulse 305 took to return is used to measure the distance from the HMD device 100 to the associated point in the environment 300. The collected distance measurements may be combined by the controller 120 to generate the three-dimensional mesh representation of the environment 300.

Returning to FIG. 1, the HMD device 100 may use head tracking and/or surface mapping to support the execution of one or more virtual reality (“VR”), augmented reality (“AR”), or mixed reality (“MR”) applications. For VR applications, each near-eye display system 110a, 110b may be opaque and may obscure the wearer's vision of the real word. Each near-eye display system 110a, 110b may further display a virtual world to the wearer that is rendered and generated by the controller 120 based on the head tracking. When the position or orientation of the HMD device 100 changes (due to the movement of the user), the controller 120 changes the rendering to give the user the impression that they are in the virtual world. An example VR application may be a videogame that allows a user to explore a virtual castle or other virtual location.

For AR applications, each near-eye display system 110a, 110b may be at least partly transparent to provide a substantially unobstructed field of view in which the wearer can directly observe their physical surroundings or environment while wearing the HMD device 100. Each near-eye display system 110a, 110b may be configured to present, in the same field of view, a computer-generated display image comprising one or more virtual objects. The virtual objects may be rendered by the controller 120 based on the head tracking such that the virtual objects appear to move or change in the environment based on the changes to the position and orientation of the HMD device 100. An example AR application may be a movie application that makes a selected movie appear to be projected on a giant virtual screen that is inserted into the field of view of the user.

MR applications are like AR applications in that they similarly project virtual objects into the field of view of the user, but for MR applications the controller 120 may additionally incorporate surface mapping to allow the virtual objects to appear integrated into the environment surrounding the wearer of the HMD device 100, and to allow the virtual objects to interact with the environment in a realistic way. An example MR application is a videogame application where the user may throw a virtual ball against a wall of the room, and the ball may appear to bounce and realistically interact with the surfaces of the room based on the surface mapping.

There are many drawbacks associated with conventional head tracking using IMUS 130 and tracking cameras 140, and with providing surface mapping using depth cameras 150. For the IMU 130 and tracking cameras 140, because of cost constraints, the generated position and orientation measurements may be unreliable. In particular, the inertial data generated by the IMU 130 may become large and unstable overtime. For example, the following Graph 1 illustrates how a bias of 1 mg in an acceleration measurement can result in an increased tracking error in the position of the HMD device 100 over time:

In order to overcome the tracking errors caused by IMUs 130 shown above, some systems may compensate by relying on tracking cameras 140 to calculate the position and orientation of the HMD device 100. For example, the framerate of the tracking cameras 140 may be increased to provide more image data that may be used to calculate more precise position and orientation calculations. However, processing the image data is computationally expensive for the controller 120 and HMD device 100, which can deprive the controller 120 of computing resources that may have otherwise been used to provide improved VR, AR, or MR applications. Moreover, such computationally expensive image data processing may result in increased heat production by the HMD device 100, which may lead to other processes to be throttled to reduce the risk of the wearer of the HMD device 100 becoming uncomfortable or even burned.

For surface mapping using depth cameras 150, there are also drawbacks. Similar to the inertial data provided by the IMU 130, the depth measurements provided by depth cameras 150 may have their own associated error. For example, the following Graph 2 illustrates how the error associated with depth measurements generated by depth cameras 150 may increase with the overall distance measured:

In order to solve these drawbacks and others, the HMD device 100 may include an electromagnetic sensor 160. The electromagnetic sensor 160 may transmit and receive electromagnetic waves that are used to measure the distance and/or velocity of the associated HMD device 100 with respect to one or more objects and surfaces within the environment of the HMD device 100. Depending on the implementation, the electromagnetic sensor 160 may be a radar sensor and may generate and receive electromagnetic waves having a frequency of approximately 7 GHz, 24 GHz, or 77 GHz, for example. Other frequencies may be used.

The electromagnetic sensor 160 may be a single sensor, or may be made up of multiple electromagnetic sensors 160. The electromagnetic sensors 160 may be placed at various locations on the HMD device 100 so that the distance and velocity of the HMD device 100 may be measured with respect to multiple surfaces and objects that may be within the environment of the HMD device 100.

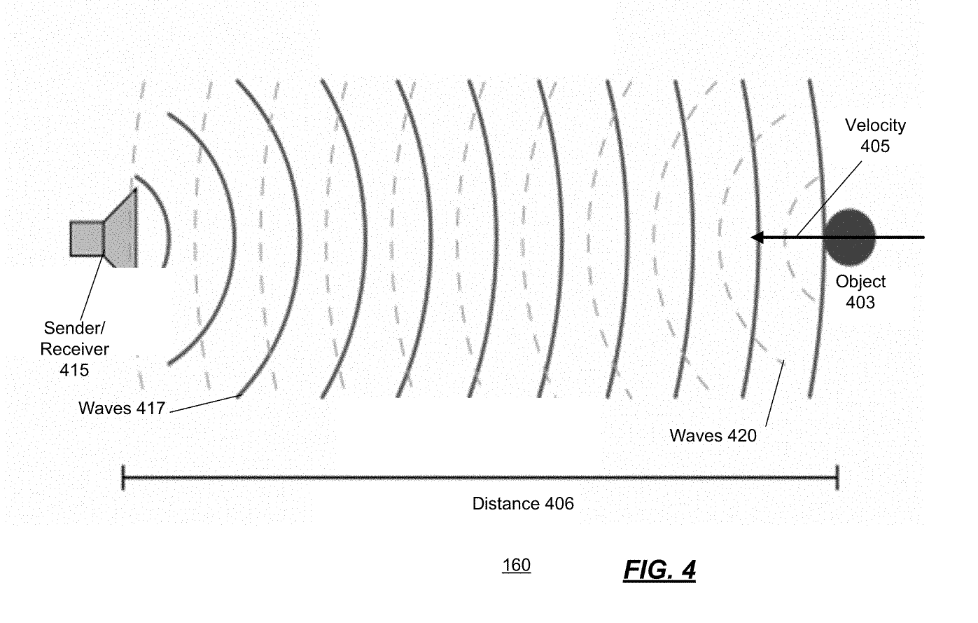

FIG. 4 is an illustration of an example electromagnetic sensor 160 that measures distance and velocity for the HMD device 100. The electromagnetic sensor 160 may include a sender/receiver 415 that transmits electromagnetic waves such as radar waves in a direction. The transmitted electromagnetic waves are shown as the waves 417 and are illustrated using the solid lines. When the waves 417 reach an object 403 (or other surface), the waves 417 are reflected back to the sender/receiver 415. The reflected electromagnetic waves are shown as the waves 420 and are illustrated using dotted lines. Depending on the implementation, the electromagnetic sensor 160 may be implemented using a single microchip.

The electromagnetic sensor 160 may measure a distance 406 between the sender/receiver 415 and the object 403 based on the time it takes for the emitted wave 417 to return to the sender/receiver 415 as the wave 420 (i.e., round-trip time) after hitting the object 403. Because the speed of the electromagnetic waves is known, the distance 406 can be determined from the round-trip time.

The electromagnetic sensor 160 may further measure a relative velocity 405 between the sender/receiver 415 and the object 403. In some implementations, the relative velocity 405 may be measured by determining changes in the frequency of the received waves 420 as compared to the transmitted waves 417. The change in frequency of the received electromagnetic wave is known as the Doppler shift, and is analogous to the change in pitch heard in a car horn as a moving car travels past the listener. Any method for determining relative velocity 405 from a change in frequency may be used.

With respect to head tracking, the distance and velocity measurements provided by the electromagnetic sensor 160 may have less error than the inertial measurements provided by the IMU 130. In particular, the velocity measurements provided by the electromagnetic sensor 160 may have less error and may be more reliable than the acceleration measurements provided by the IMU 130.

Accordingly, the need to rely on high frame rate tracking cameras 140 to correct for the IMU 130 may be reduced or eliminated. Such reduction may allow the controller 120 to spend less resources on head tracking and spend more resources on one or more applications. For example, the extra resources available to the controller 120 may be used to increase the resolution or framerate of the application used by the wearer of the HMD device 100. According, the functioning of the computer (i.e., controller 120 and HMD device 100) is improved with respect to AR, VR, and MR applications.

With respect to surface mapping, by using the distance measurements provided by the electromagnetic sensor 160 in place of the distance measurements provided by the depth camera 150, the accuracy of the resulting three-dimensional mesh is greatly increased. The distance measurements provided by the electromagnetic sensor 160 are not associated with the same errors as the distance measurements provided by the depth camera 150. Such improved measurements may lead to more accurate three-dimensional meshes, which may lead to an improved AR or MR application experience for the wearer of the HMD device 100.

The electromagnetic sensor 160 may provide further advantages to VR, AR, and MR applications. One such advantage is object detection. When wearing the HMD device 100, the vision of the wearer may be reduced when participating in AR and MR applications, or completely obscured when participating in VR applications. As a result, the wearer may be susceptible to tripping over objects or colliding with objects. Traditional sensors such as the depth camera 150 and the tracking cameras 140 are limited to collecting data from objects that are in front of the wearer or within the field of view of the wearer, and cannot detect object hazards that are close to the wearer's feet or to the side of the wearer. In contrast, the electromagnetic sensor 160 may be configured to transmit and receive electromagnetic waves in a variety of directions including outside of the field of view of the wearer, allowing it to detect objects that may be close to the wearer but outside of their field of view. When such objects are detected, the controller 120 may alert the wearer by displaying a warning to the wearer, or even disabling the application executing on the HMD device 100.

Object detection may also be used to detect non-hazardous objects such as the hands of the wearer. Previously, if a participant in a VR application desired to incorporate their hands (or other body parts) in the VR application they had to wear special gloves that allowed to the position and orientation of their hands to be tracked. However, the object detection capabilities of the electromagnetic sensor 160 may allow the position and orientation of the wearer's hand to be tracked and determined without the use of special gloves.

The electromagnetic sensor 160 may allow other objects to be detected and incorporated into VR, AR, and MR applications such as a steering wheel for a driving application, a fake gun for a first person shooting application, or instruments for a musical or “Rock Band” type application. The position and the orientation of the objects may be tracked and determined by the electromagnetic sensor 160 without the use of any tracking means being integrated into the objects themselves.

Still another advantage of the electromagnetic sensor 160 is the ability of the electromagnetic sensor 160 to “see through” different surfaces or to be tuned to detect certain materials. In particular, the frequency of the electromagnetic waves emitted by the electromagnetic sensor 160 may be adjusted so that they may pass through certain materials or that they may be reflected by certain materials. For example, an MR application may be provided that allows a user to see pipes or wires that are hidden behind drywall, by adjusting the frequency of the electromagnetic waves emitted by the electromagnetic sensor 160 to a frequency that passes through drywall, but that is reflected by pipes and wires. The resulting three-dimensional mesh generated by the controller 120 using such a frequency would show the pipes and wires, but not the drywall.

Returning to FIG. 1, no aspect of FIG. 1 is intended to be limiting in any sense, for numerous variants are contemplated as well. In some embodiments, a single near-eye display system extending over both eyes may be used instead of the dual monocular near-eye display systems 110A and 1106 shown in FIG. 1. In addition, in some implementations, the electromagnetic sensor 160 may be located outside, or may be separate from the HMD device 100. For example, one or more electromagnetic sensors 160 may be located in a staff or cane held by the wearer of the HMD device 100, or may be located on a piece of clothing or badge worn by the wearer of the HMD device 100. In such implementations, the electromagnetic sensor 160 may be communicatively coupled to the HMD device 100 using a wire or a wireless communication protocol.

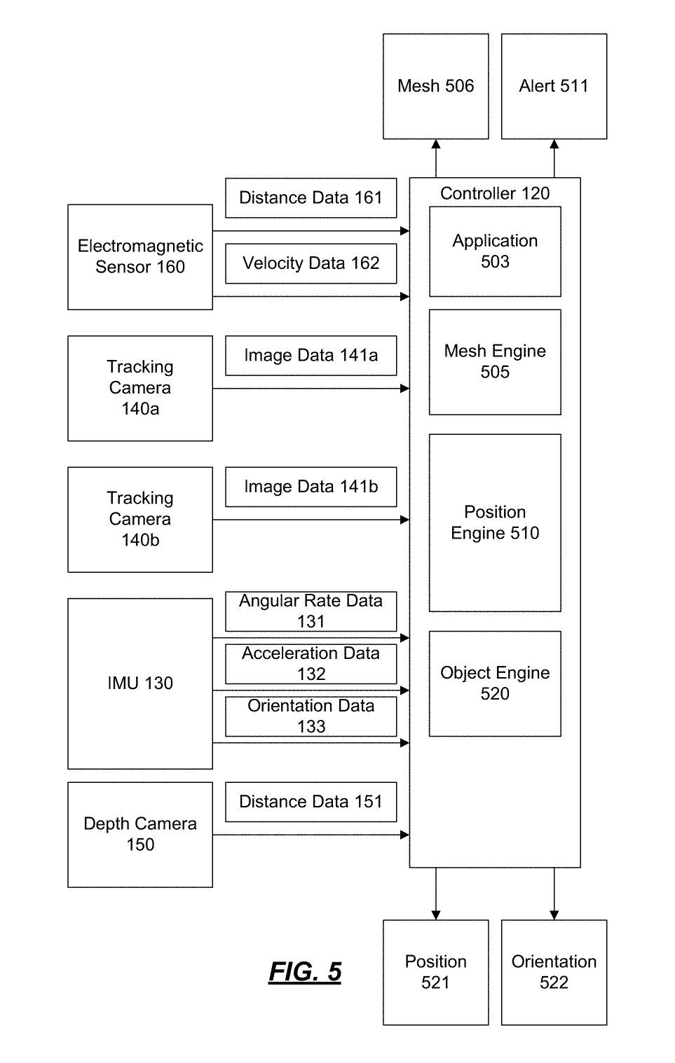

FIG. 5 is an illustration of an example controller 120 that may be incorporated into an HMD device 100. In the example shown, the controller 120 includes several components including an application 503, a mesh engine 505, a position engine 510, and an object engine 520. More or fewer components may be supported. The controller 120 may be implemented using a general purpose computing device such as the computing device 1100 described with respect to FIG. 11.

The application 503 may be one or more of a VR, AR, or MR application. The controller 120 may execute the application 503, and may provide the application 503 data generated by the other components of the controller 120 such as a mesh 506, a position 521, and an orientation 522. The mesh 506 may be used by the application 503 to perform surface mapping. The position 521 and the orientation 522 may be used by the application 503 to perform head tracking.

The mesh engine 505 may receive distance data 151 generated by the depth camera 150, and may use the received distance data 151 to generate the mesh 506. The mesh 506 may be a three-dimensional mesh and may be a three-dimensional representation of an environment of the wearer of the corresponding HMD device 110. Depending on the implementation, the depth camera 150 may generate the distance data 151 using a laser. As described above, the distance measurements that comprise the distance data 151 may be associated with an error that grows as the distance grows.

Alternatively or additionally, the mesh engine 505 may receive distance data 161 from one or more electromagnetic sensors 160. The electromagnetic sensor 160 may be a single sensor, or an array of sensors, and may use electromagnetic waves to measure the distance between the electromagnetic sensor 160 and one or more points or surfaces within the environment of the wearer of the corresponding HMD device 100. The measured distances may be provided to the mesh engine 505 as the distance data 161.

Depending on the implementation, the electromagnetic sensor 160 may use radar to generate the distance data 161. Distance data 161 generated using radar may be more accurate than the distance data 151 generated using the depth camera 150. For example, distance measurements made by some depth cameras 150 may be accurate to approximately 11 mm +0.1% of the distance measured. Thus, at a distance of five meters the distance data 151 measured by these depth cameras 150 would have an expected error of 16 mm. In contrast, for the electromagnetic sensor 160 using radar, at the same distance, the distance data 161 measured by the electromagnetic sensor 160 would have an expected error of 1 cm or less. Other types of depth cameras 150 may be associated with greater error.

As may be appreciated, by the mesh engine 505 generating the mesh 506 using the distance data 161 provided by the electromagnetic sensor 160 rather than the distance data 151 provided by the depth camera 150, the accuracy of the resulting mesh 506 is increased. A more accurate mesh 506 may allow for more realistic and convincing AR and MR applications 503, which is an improvement to the functioning of the controller 120 or the HMD device 100.

The position engine 510 may receive inertial data from the IMU 130, and may use the received inertial data to generate one or both of the position 521 and the orientation 522 of the corresponding HMD device 100. Depending on the implementation, the inertial data may include angular rate data 131, acceleration data 132, and orientation data 133. Other types of inertial data may be supported. The position engine 510 may use the collected angular rate data 131, acceleration data 132, and orientation data 133 to determine the position 521 and orientation 522 using any method or technique known in the art for generating the position 521 and the orientation 522 using inertial data.

The position engine 510 may further improve the accuracy of the position 521 and the orientation 522 calculations by also considering image data 141a, 141b generated by one or more tracking cameras 140a, 140b. Each tracking camera 140a, 140b may generate image data 141a, 141b, respectively, that captures points that are associated with one or more objects or surfaces that are visible in the environment of the wearer of the HMD device 100 by the tracking camera 140a, 140b. The tracking camera 140a may generate image data 141a that includes images of points that are visible to the tracking camera 140a, and the tracking camera 140b may generate image data 141b that includes images of points that are visible to the tracking camera 140b. As the wearer of the HMD device 100 moves their head, the positions of the various points visible in the image data 141a and 141b may change. The position engine 510 may measure the changes in position of the various points, and may use the measured changes to calculate the position 521 and the orientation 522 of the HMD device 100.

As described above, because of quality issues associated with the IMU 130, the inertial data received from the IMU 130 may be associated with error. In particular, the error associated with the generated acceleration data 132 may increase over time. In order to compensate for error in the acceleration data 132, the position engine 510 may increasingly rely on the image data 141a, 141b from the tracking cameras 140a, 140b to provide high quality position 521 and orientation 522 determinations. However, because of increased processing costs associated with processing image data 141a, 141b, reliance on image data 141a, 141b for position 521 and orientation 522 calculation may result in fewer processing resources available for applications 503. Fewer processing resources may lead to reduced graphical complexity for the applications 503, and may cause a diminished experience for the wearer of the HMD device 100.

In order to overcome errors associated with the acceleration data 132 without increased reliance on tracking cameras 140a, 140b, the position engine 510 may further receive velocity data 162 from the electromagnetic sensor 160. The velocity data 162 may be a relative velocity between the electromagnetic sensor 160 and an object or surface within the environment of the HMD device 100. The electromagnetic sensor 160 may generate the velocity data 162 based on a change in frequency of electromagnetic waves transmitted and received by the electromagnetic sensor 160.

Calculating the position 521 and the orientation 522 using velocity data 162 instead of acceleration data 132 may result in improved head tracking. First, the electromagnetic sensor 160 is more accurate than the IMU 130, which may result in velocity data 162 that has less error than the acceleration data 132. Second, because of the different way that the position 521 and the orientation 522 are calculated from velocity data 162 than acceleration data 132, errors associated with acceleration data 132 may grow faster than similar errors associated with the velocity data 162. In particular, the acceleration data 132 may be double-integrated (in time) when calculating the position 521, while the velocity data 132 may only be single-integrated. Therefore, errors in the acceleration data 132 contribute to errors in the calculation of the position 521 that grow with the square of time, while errors in the velocity data 162 may contribute to errors in the calculation of the position 521 that grow linearly with time.

As a result, the use of velocity data 162 is superior to acceleration data 132 over longer time scales, which will improve the calculation of the position 521 and the orientation 522 for purposes of head tracking. Such improved head tracking may result in more realistic AR, MR, and VR applications 503, which is an improvement to the functioning of the controller 120 and the HMD device 100. In addition, the improved head tracking may allow tracking cameras 140 to operate at a lower frame-rate, which may save power and computational resources.

The object engine 520 may detect one or more objects within a threshold distance of the controller 120 and/or HMD device 100 using the distance data 161. One drawback associated with applications 503 where the vision of the user is either totally obscured by virtual objects (i.e., VR applications 503), or partially obscured by virtual objects (i.e., AR or MR applications 503), is that the user may be vulnerable to colliding with objects or other surfaces of the environment while participating in the applications 503. To help avoid such collisions, the object engine 520 may detect objects in the environment that are within a threshold distance of the HMD device 100, and may generate an alert 511 in response to the determination. The alert 511 may be a visual alert that is displayed to the wearer of the HMD device 100, or an audio alert 511 that is played to the wearer of the HMD device 100.

In some implementations, the object engine 520 may detect the objects within the threshold distance using the distance data 161 generated by the electromagnetic sensor 160. Unlike the depth camera 150 that is typically limited to generating distance data 151 for objects that are within a field of view of the wearer of the HMD device 100, the electromagnetic sensor 160 may be an array or plurality of sensors 160 that may be capable of generating distance data 161 that includes distance measurements for objects and surfaces that may be outside of the field of view of the wearer.

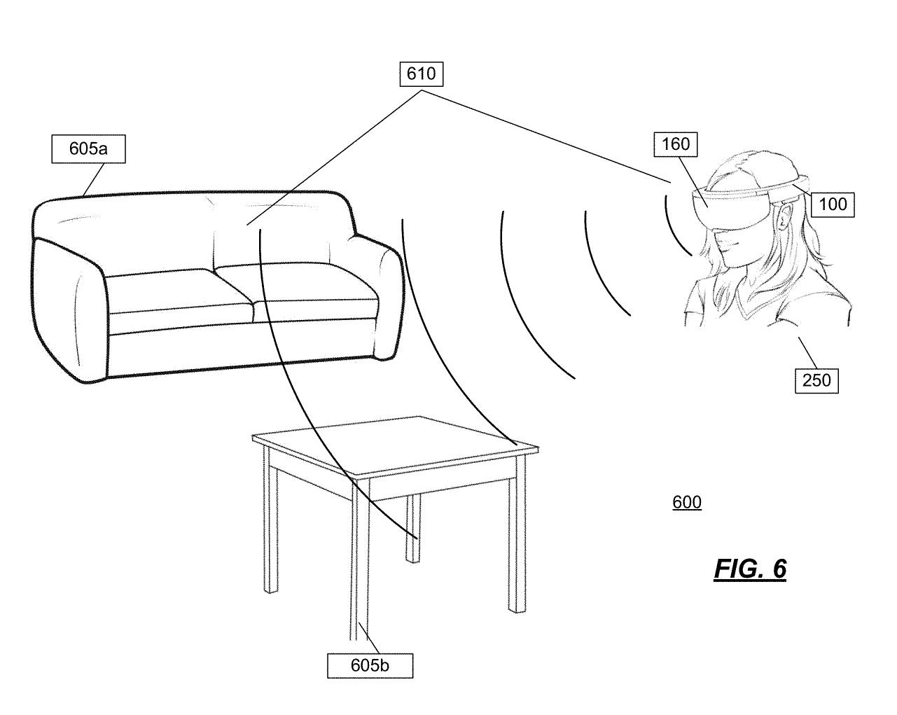

FIG. 6 is an illustration of an example environment 600 that includes an HMD device 100 performing object detection. As the wearer 250 of the HMD device 100 moves their head and the HMD device 100 within the environment 600, the electromagnetic sensor 160 may transmit electromagnetic waves 610. As shown, the environment 600 includes two objects 605 (i.e., the objects 605a and 605b). Note that for purposes of simplicity, the electromagnetic sensor 160 is shown generating the electromagnetic waves 610 in a single direction, however in practice the electromagnetic sensor 160 may generate the electromagnetic waves 610 in multiple directions around the wearer 250.

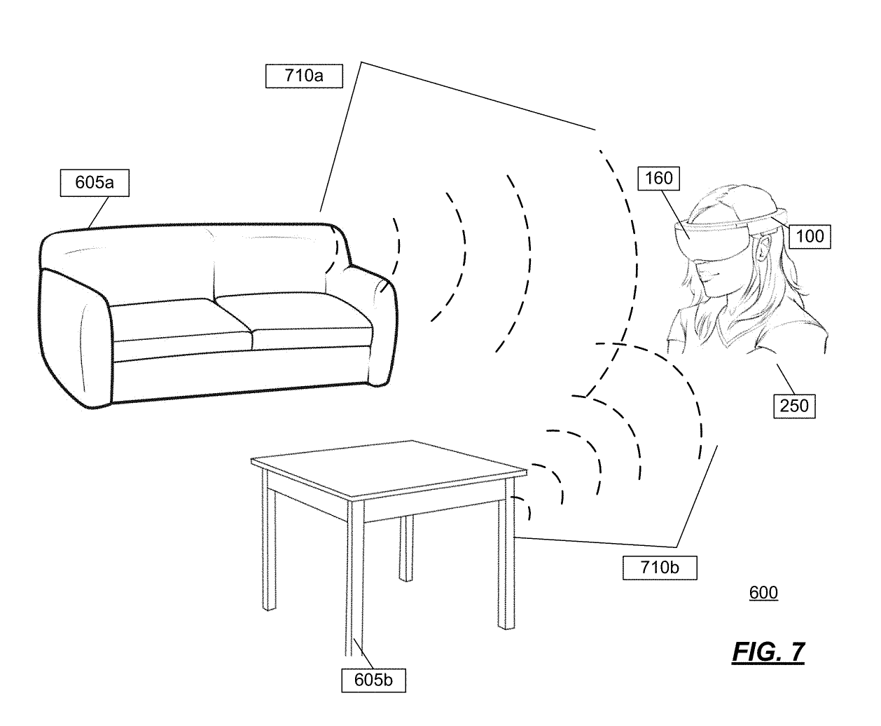

Continuing to FIG. 7, the electromagnetic waves 610 emitted by the electromagnetic sensor 160 have collided with the object 605a and 605b in the environment 600. As a result of the collision, the electromagnetic waves 610 are reflected back towards the electromagnetic sensor 160 as the electromagnetic waves 710. In the example shown, the electromagnetic waves 610 that collided with the object 605a are reflected back as the electromagnetic waves 710a, and the electromagnetic waves 610 that collided with the object 605b are reflected back as the electromagnetic waves 710b.

The elapsed time between the transmission of the electromagnetic waves 610, and the receipt of the electromagnetic waves 710a may be used by the object engine 520 to determine the distance between the object 605a and the electromagnetic sensor 160. Similarly, the elapsed time between the transmission of the electromagnetic waves 610, and the receipt of the electromagnetic waves 710b may be used by the object engine 520 to determine the distance between the object 605b and the electromagnetic sensor 160. If either distance is less than a threshold distance, then the object engine 520 may generate an alert 511.

Returning to FIG. 5, the object engine 520 may also generate an alert 511 when a velocity of an object or surface in the environment of the HMD device 100 exceeds a threshold velocity. The object engine 520 may use the velocity data 162 generated by the electromagnetic sensor 160 to determine that an object with a velocity that is greater than a threshold velocity is approaching the HMD device 100, or alternatively that the HMD device 100 is moving towards a surface of the environment with a velocity that is greater than the threshold velocity. For example, the object engine 520 may detect that a ball, or other object, is moving towards the HMD device 100, or that the HMD device 100 is moving towards a wall. Depending on the implementation, the generated alert 511 may be displayed by the HMD device 100 and may identify the object or surface that exceeds the threshold velocity.

The object engine 520 may further allow for the tracking and integration of one or more objects into one or more applications 503. For example, an application 503 focused on sword fighting may allow a wearer of the HMD device 100 to hold a dowel, stick, or other object. The object engine 520 may use the distance data 161 and velocity data 162 to track the location and orientation of the object as the user moves the object in the environment surrounding the HMD device 100. The application 503 may use the tracked location and orientation of the object to render and display a sword in the application 503 such that the wearer of the HMD device 100 has the experience of controlling the displayed sword using the real world object. As may be appreciated, a variety of objects can be tracked by the object engine 520 using the electromagnetic sensor 160 including the hands and feet of the wearer of the HMD device 100.

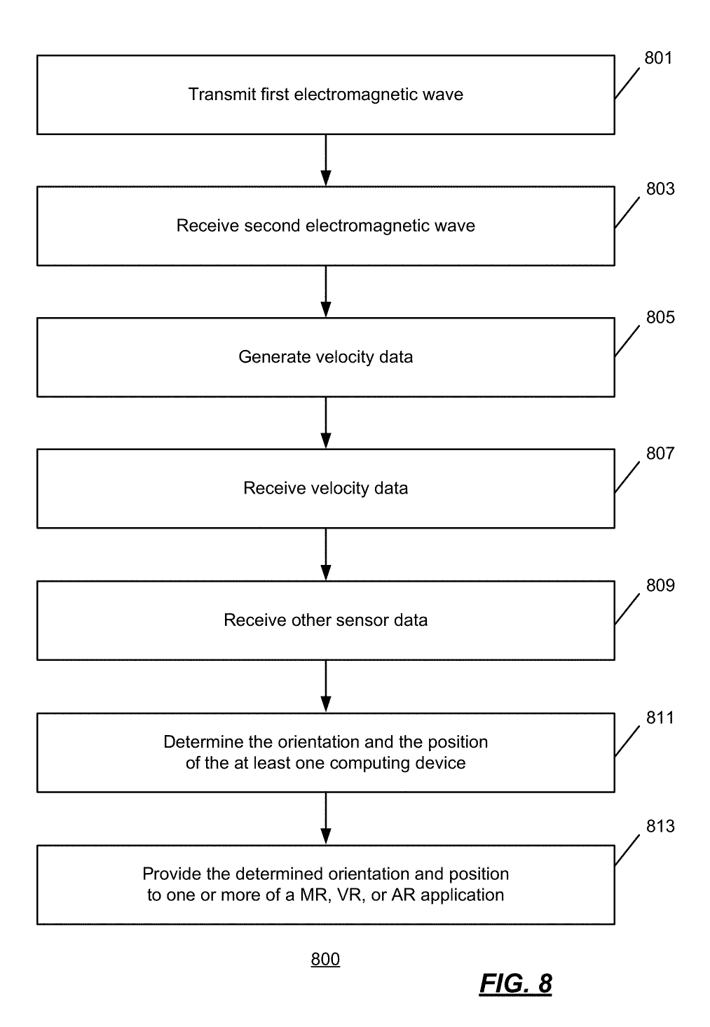

FIG. 8 is an operational flow of an implementation of a method 800 for determining an orientation 522 and/or a position 521 of an HMD device 100. The method 800 may be implemented by a controller 120 and an electromagnetic sensor 160 of the HMD device 100.

At 801, a first electromagnetic wave is transmitted. The first electromagnetic wave may be transmitted by the electromagnetic sensor 160 of the HMD device 100. The electromagnetic sensor 160 may be a radar sensor and the first electromagnetic wave may be a radar wave. The electromagnetic sensor 160 may be located on the HMD device 100, or may be external to the HMD device 100 and may be integrated into a held-held controller or article of clothing worn by a wearer of the HMD device 100. The HMD device 100 may be used by the wearer to participate in one or more AR, VR, or MR applications 503. The AR, VR, or MR application(s) 503 may be executed by the controller 120 of the HMD device 100.

At 803, a second electromagnetic wave is received. The second electromagnetic wave may be received by the electromagnetic sensor 160 of the HMD device 100. The second electromagnetic wave may be some or all of the first electromagnetic wave after having been reflected off of a surface of an environment surrounding the HMD device 100.

At 805, velocity data is generated. The velocity data 162 may be generated by the electromagnetic sensor 160 of the HMD device 100. In some implementations, the velocity data 162 may be generated by comparing the wavelengths of the first electromagnetic wave and the second electromagnetic wave to determine a Doppler shift. The velocity data 162 may indicate a relative velocity between the electromagnetic sensor 160 and the surface of the environment that reflected the second electromagnetic wave.

At 807, the velocity data is received. The velocity data 162 may be received by the controller 120 of the HMD device 100 from the electromagnetic sensor 160.

At 809, other sensor data is received. The other sensor data may include inertial data such as angular rate data 131 and orientation data 133 may be received from an IMU 130 of the HMD device 100. In addition, the other sensor data may include image data 141 received from one or more tracking cameras 140 of the HMD device 100. Other types of sensor data may be received such as GPS data or beacon data.

At 811, an orientation and a position of the HMD device 100 is determined. The orientation 522 and position 521 of the HMD device 100 may be determined by the controller 120 using the received velocity data 162 and the other sensor data. In addition, the controller 120 may determine a spatial position of the HMD device 100 using the velocity data. Depending on the implementation, the controller 120 may consider the angular rate data 131, orientation data 133, and the image data 141 when determining the orientation 522 and position 521 of the HMD device 100. Any method for determining the orientation 522 and the position 521 may be used.

At 813, the determined orientation and position are provided to one or more of the MR, VR, or AR applications executing on the HMD device 100. The determined orientation 522 and position 521 may be provided by the controller 120 to the application 503. The application 503 may use the determined orientation 522 and position 521 to render one or more virtual objects or virtual environments displayed to the wearer of the HMD device 100.

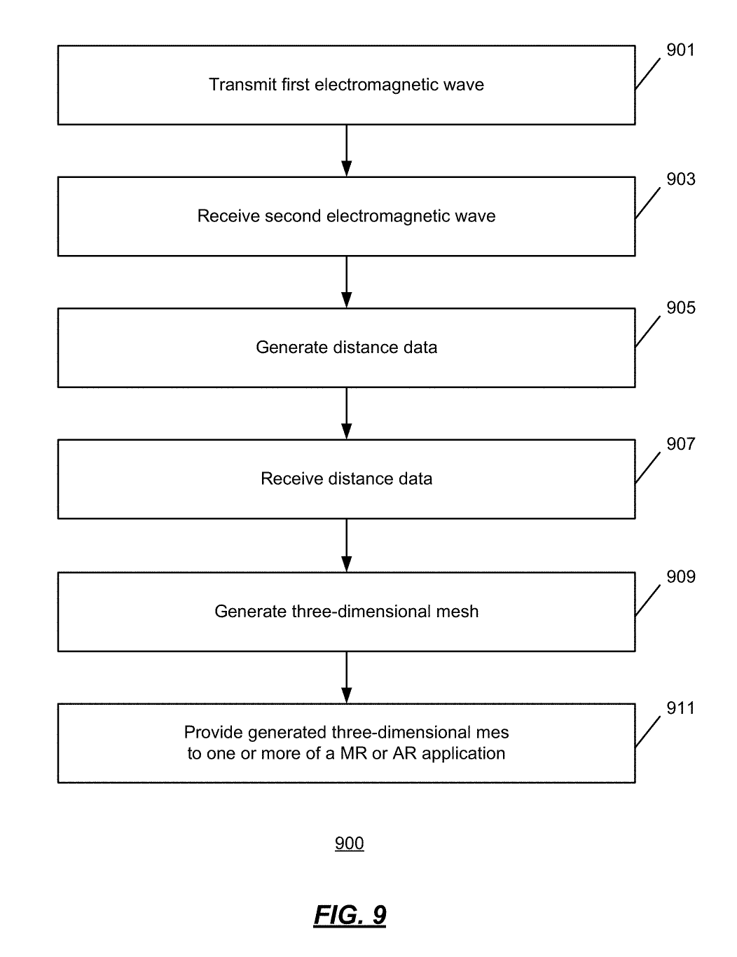

FIG. 9 is an operational flow of an implementation of a method 900 for determining a three-dimensional mesh 506 using an electromagnetic sensor 160 of an HMD device 100. The method 900 may be implemented by a controller 120 and an electromagnetic sensor 160 of the HMD device 100.

At 901, a first electromagnetic wave is transmitted. The first electromagnetic wave may be transmitted by the electromagnetic sensor 160 of the HMD device 100. The electromagnetic sensor 160 may be a radar sensor and the first electromagnetic wave may be a radar wave. The HMD device 100 may be used by the wearer to participate in one or more AR or MR applications 503. The AR or MR application(s) 503 may be executed by the controller 120 of the HMD device 100.

At 903, a second electromagnetic wave is received. The second electromagnetic wave may be received by the electromagnetic sensor 160 of the HMD device 100. The second electromagnetic wave may be reflected off of a surface of an environment surrounding the HMD device 100.

At 905, distance data is generated. The distance data 161 may be generated by the electromagnetic sensor 160 of the HMD device 100. In some implementations, the distance data 161 may be generated by determining how long it took the first electromagnetic wave to return to the electromagnetic sensor 160 as the second electromagnetic wave.

At 907, the distance data is received. The distance data 161 may be received by the controller 120 of the HMD device 100 from the electromagnetic sensor 160.

At 909, a three-dimensional mesh is generated. The three-dimensional mesh 506 may be generated by the controller 120 using the distance data 161 received from the electromagnetic sensor 160. Over time, the controller 120 may receive distance data 161 including distance measurements corresponding to a variety of surfaces and points within the environment of the wearer of the HMD device 100. The controller 120 may generate the three-dimensional mesh 506 by combining the various distance measurements. Depending on the implementation, the controller 120 may also consider the orientation 522 and position 521 of the HMD device 100 when each of the distance measurements was generated or received. Any method for generating a three-dimensional mesh 506 may be used.

At 911, the generated three-dimensional mesh 506 is provided to one or more of the MR or AR applications 503 executing on the HMD device 100. The three-dimensional mesh 506 may be provided by the controller 120 to the application 503. The application 503 may use the three-dimensional mesh 506 to render one or more virtual objects such that they appear to be part of the environment of the wearer when displayed by the HMD device 100.

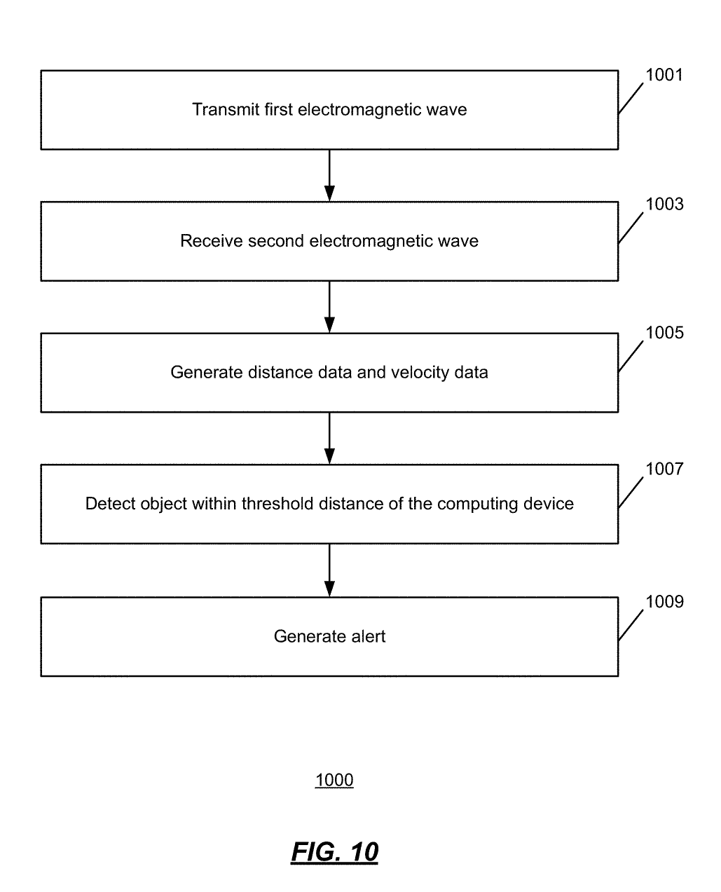

FIG. 10 is an operational flow of an implementation of a method 1000 for detecting objects using an electromagnetic sensor 160 of an HMD device 100. The method 1000 may be implemented by a controller 120 and an electromagnetic sensor 160 of the HMD device 100.

At 1001, a first electromagnetic wave is transmitted. The first electromagnetic wave may be transmitted by the electromagnetic sensor 160 of the HMD device 100. Depending on the implementation, there may be an array or plurality of electromagnetic sensors 160, and each electromagnetic sensor 160 may transmit a first electromagnetic wave in a different direction with respect to the HMD device 100. The HMD device 100 may be used by the wearer to participate in one or more VR, AR, or MR applications 503.

At 1003, a second electromagnetic wave is received. The second electromagnetic wave may be received by the electromagnetic sensor 160 of the HMD device 100. The received second electromagnetic wave may be some or all of the first electromagnetic wave after having been reflected off of a surface of an environment surrounding the HMD device 100. Where a plurality of electromagnetic sensors 160 are used, some or all of the electromagnetic sensors 160 may receive a second electromagnetic wave reflected off of a different surface within the environment.

At 1005, distance and velocity data are generated. The distance data 161 and velocity data 162 may be generated by the electromagnetic sensor 160 of the HMD device 100. In some implementations, the distance data 161 may be generated by determining how long it took the first electromagnetic wave to return as the second electromagnetic wave, and the velocity data 162 may be generated by determining a Doppler shift between a wavelength of the first electromagnetic wave and the second electromagnetic wave. Where a plurality of electromagnetic sensors 160 are used, some or all of the electromagnetic sensors 160 may generate the velocity data 162 and distance data 161.

At 1007, an object is detected within a threshold distance of the HMD device 100. The object may be detected by the controller 120 based on the velocity data 162 and the distance data 161. The threshold distance may be set by a user or an administrator. Depending on the implementation, the controller 120 may further detect objects and/or surfaces that are moving towards the wearer of the HMD device 100 with a velocity that is greater than a threshold velocity. The threshold velocity may similarly be set by a user or an administrator.

At 1009, an alert is generated. The alert 511 may be generated by the controller 120 in response to detecting the object within the threshold distance or having the threshold velocity. Depending on the implementation, the controller 120 may generate the alert 511 by rendering and displaying a visual indicator to the wearer of the HMD device 100. The visual indicator may indicate the direction that the detected object is located at with respect to the HMD device 100. Other information such as the velocity of the object may be indicated by the alert 511. Depending on the implementation, the controller 120 may disable the application 503 until it is determined that the detected object is no longer a threat to the wearer of the HMD device 100.

FIG. 11 shows an exemplary computing environment in which example embodiments and aspects may be implemented. The computing device environment is only one example of a suitable computing environment and is not intended to suggest any limitation as to the scope of use or functionality.

Numerous other general purpose or special purpose computing devices environments or configurations may be used. Examples of well-known computing devices, environments, and/or configurations that may be suitable for use include, but are not limited to, personal computers, server computers, handheld or laptop devices, multiprocessor systems, microprocessor-based systems, network personal computers (PCs), minicomputers, mainframe computers, embedded systems, distributed computing environments that include any of the above systems or devices, and the like.

Computer-executable instructions, such as program modules, being executed by a computer may be used. Generally, program modules include routines, programs, objects, components, data structures, etc. that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

With reference to FIG. 11, an exemplary system for implementing aspects described herein includes a computing device, such as computing device 1100. In its most basic configuration, computing device 1100 typically includes at least one processing unit 1102 and memory 1104. Depending on the exact configuration and type of computing device, memory 1104 may be volatile (such as random access memory (RAM)), non-volatile (such as read-only memory (ROM), flash memory, etc.), or some combination of the two. This most basic configuration is illustrated in FIG. 11 by dashed line 1106.

Computing device 1100 may have additional features/functionality. For example, computing device 1100 may include additional storage (removable and/or non-removable) including, but not limited to, magnetic or optical disks or tape. Such additional storage is illustrated in FIG. 11 by removable storage 1108 and non-removable storage 1110.

Computing device 1100 typically includes a variety of computer readable media. Computer readable media can be any available media that can be accessed by the device 1100 and includes both volatile and non-volatile media, removable and non-removable media.

Computer storage media include volatile and non-volatile, and removable and non-removable media implemented in any method or technology for storage of information such as computer readable instructions, data structures, program modules or other data. Memory 1104, removable storage 1108, and non-removable storage 1110 are all examples of computer storage media. Computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 1100. Any such computer storage media may be part of computing device 1100.

Computing device 1100 may contain communication connection(s) 1112 that allow the device to communicate with other devices. Computing device 1100 may also have input device(s) 1114 such as a keyboard, mouse, pen, voice input device, touch input device, etc. Output device(s) 1116 such as a display, speakers, printer, etc. may also be included. All these devices are well known in the art and need not be discussed at length here.

It should be understood that the various techniques described herein may be implemented in connection with hardware components or software components or, where appropriate, with a combination of both. Illustrative types of hardware components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. The methods and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium where, when the program code is loaded into and executed by a machine, such as a computer, the machine becomes an apparatus for practicing the presently disclosed subject matter.

In an implementation, a system for providing augmented reality, mixed reality, and virtual reality applications using at least one electromagnetic sensor is provided. The system includes: at least one computing device; a controller; and an electromagnetic sensor. The electromagnetic sensor: transmits a first electromagnetic wave; receives a second electromagnetic wave; and based on the first electromagnetic wave and the second electromagnetic wave, generates velocity data. The controller: receives the generated velocity data; based on the velocity data, determines a position of the at least one computing device; and provides the determined position to one or more of a mixed reality, augmented reality, or a virtual reality application executed by the at least one computing device.

Implementations may include some or all of the following features. The electromagnetic sensor may be a radar sensor. The first electromagnetic wave may have a frequency of 7 GHz, 24 GHz, or 77 GHz. The controller further: based on the velocity data, determines a spatial position of the at least one computing device. The controller further: receives distance data from the electromagnetic sensor; based on the distance data, determines an object within a threshold distance of the at least one computing device; and in response to the determination, generates an alert. The at least one computing device comprises a head-mounted display device. The system may further include an inertial measurement unit that generates angular rate data and orientation data. The controller further: based on the velocity data, the angular rate data, and the orientation data, determines the position of the at least one computing device. The system may further include a tracking camera that generates image data. The controller further: based on the velocity data and the image data, determines the position of the at least one computing device. The controller further: receives distance data from the electromagnetic sensor; and based on the received distance data, generates a three-dimensional mesh.

In an implementation, a system for providing augmented reality and mixed reality applications using at least one electromagnetic sensor is provided. The system includes: at least one computing device; a controller; and an electromagnetic sensor. The electromagnetic sensor: transmits a first electromagnetic wave; receives a second electromagnetic wave; and based on the first electromagnetic wave and the second electromagnetic wave, generates distance data. The controller: receives the generated distance data; based on the distance data, generates a three-dimensional mesh; and provides the generated three-dimensional mesh to a mixed reality application or an augmented reality application executing on the at least one computing device.

Implementations may include some or all of the following features. The electromagnetic sensor may be a radar sensor. The first electromagnetic wave may have a frequency in the range of 7 GHz, 24 GHz, or 77 GHz. The electromagnetic sensor further: based on the first electromagnetic wave and the second electromagnetic wave, generates velocity data. The controller further: receives the generated velocity data; and based on the received velocity data, determines a position of the at least one computing device. The controller further: based on the received velocity data, determines a spatial position of the at least one computing device. The system may further include a tracking camera that generates image data. The controller further: based on the distance data and the image data, determines the position of the at least one computing device.

In an implementation, a method for providing augmented reality applications, mixed reality applications, and virtual reality applications using at least one electromagnetic sensor is provided. The method includes: transmitting a first electromagnetic wave by an electromagnetic sensor of a computing device; receiving a second electromagnetic wave by the electromagnetic sensor of the computing device; based on the first electromagnetic wave and the second electromagnetic wave, generating velocity data by the computing device; receiving inertial data from an inertial measurement unit of the computing device; based on the received inertial data and the generated velocity data, determining an orientation and a position of the computing device by the computing device; and providing the determined orientation and position to one of an augmented reality application, a mixed reality application, or a virtual reality application executing on the computing device by the computing device.

Implementations may include some or all of the following features. The electromagnetic sensor may be a radar sensor. The first electromagnetic wave may have a frequency in the range of 7 GHz, 24 GHz, or 77 GHz. The computing device may be a head-mounted display device. The method may further include: based on the first electromagnetic wave and the second electromagnetic wave, generating distance data; and based on the distance data, generating a three-dimensional mesh.

Although exemplary implementations may refer to utilizing aspects of the presently disclosed subject matter in the context of one or more stand-alone computer systems, the subject matter is not so limited, but rather may be implemented in connection with any computing environment, such as a network or distributed computing environment. Still further, aspects of the presently disclosed subject matter may be implemented in or across a plurality of processing chips or devices, and storage may similarly be effected across a plurality of devices. Such devices might include personal computers, network servers, and handheld devices, for example.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A system for providing augmented reality, mixed reality, and virtual reality applications using at least one electromagnetic sensor, the system comprising:
at least one computing device;
a controller; and
an electromagnetic sensor that:
transmits a first electromagnetic wave;
receives a second electromagnetic wave; and
based on the first electromagnetic wave and the second electromagnetic wave, generates velocity data,
wherein the controller:
receives the generated velocity data;
based on the velocity data, determines a position of the at least one computing device; and
provides the determined position to one or more of a mixed reality application, an augmented reality application, or a virtual reality application executed by the at least one computing device.

2. The system of claim 1, wherein the electromagnetic sensor is a radar sensor.

3. The system of claim 1, wherein the first electromagnetic wave has a frequency of 7 GHz, 24 GHz, or 77 GHz.

4. The system of claim 1, wherein the controller, based on the velocity data, determines a spatial position of the at least one computing device.

5. The system of claim 1, wherein the controller further:
receives distance data from the electromagnetic sensor;
based on the distance data, determines an object within a threshold distance of the at least one computing device; and
in response to the determination, generates an alert.

6. The system of claim 1, wherein the at least one computing device comprises a head-mounted display device.

7. The system of claim 1, further comprising an inertial measurement unit that generates angular rate data and orientation data, and wherein the controller further:
based on the velocity data, the angular rate data, and the orientation data, determines the position of the at least one computing device.

8. The system of claim 1, further comprising a tracking camera that generates image data, and wherein the controller further:
based on the velocity data and the image data, determines the position of the at least one computing device.

9. The system of claim 1, wherein the controller further:
receives distance data from the electromagnetic sensor; and
based on the received distance data, generates a three-dimensional mesh.

10. A system for providing augmented reality and mixed reality applications using at least one electromagnetic sensor, the system comprising:
at least one computing device;
a controller; and
an electromagnetic sensor that:
transmits a first electromagnetic wave;
receives a second electromagnetic wave; and
based on the first electromagnetic wave and the second electromagnetic wave, generates distance data, wherein the controller:
receives the generated distance data;
based on the distance data, generates a three-dimensional mesh; and
provides the generated three-dimensional mesh to a mixed reality application or an augmented reality application executing on the at least one computing device.

11. The system of claim 10, wherein the electromagnetic sensor is a radar sensor.

12. The system of claim 10, wherein the first electromagnetic wave has a frequency in the range of 7 GHz, 24 GHz, or 77 GHz.

13. The system of claim 10, wherein the electromagnetic sensor further:
based on the first electromagnetic wave and the second electromagnetic wave, generates velocity data, and wherein the controller further:
receives the generated velocity data; and
based on the received velocity data, determines a position of the at least one computing device.

14. The system of claim 10, wherein the controller further, based on the received velocity data, determines a spatial position of the at least one computing device.

15. The system of claim 10, further comprising a tracking camera that generates image data, and wherein the controller further:
based on the distance data and the image data, determines the position of the at least one computing device.

16. A method for providing augmented reality applications, mixed reality applications, and virtual reality applications using at least one electromagnetic sensor, the method comprising:
transmitting a first electromagnetic wave by an electromagnetic sensor of a computing device;
receiving a second electromagnetic wave by the electromagnetic sensor of the computing device;
based on a change in frequency between the first electromagnetic wave and the second electromagnetic wave, generating velocity data by the computing device;
receiving inertial data from an inertial measurement unit of the computing device;
based on the received inertial data and the generated velocity data, determining an orientation and a position of the computing device by the computing device; and
providing the determined orientation and position to one of an augmented reality application, a mixed reality application, or a virtual reality application executing on the computing device.

17. The method of claim 16, wherein the electromagnetic sensor is a radar sensor.

18. The method of claim 16, wherein the first electromagnetic wave has a frequency in the range of 7 GHz, 24 GHz, or 77 GHz.

19. The method of claim 16, wherein the computing device is a head-mounted display device.

20. The method of claim 16, further comprising:
based on the first electromagnetic wave and the second electromagnetic wave, generating distance data; and
based on the distance data, generating a three-dimensional mesh.
